(19) United States
(12) Patent Application Publication
(10) Pub. No.: US 2020/0001672 A1
(43) Pub. Date: Jan. 2, 2020

(54) Demountable Hitching Device for Towing by Vehicles, and Associated Unlocking Device

(71) Applicant: Hermanos Sanchez Lafuente, S.A., Campanillas (ES)

(72) Inventor: Francisco Sanchez Lafuente Ayala, Campanillas (ES)

(21) Appl. No.: 16/125,908

(22) Filed: Sep. 10, 2018

(30) Foreign Application Priority Data
Jun. 27, 2018 (ES) 201830994

(51) Int. Cl. B60D 1/52; B60D 1/06

(52) U.S. Cl. CPC B60D 1/52; B60D 1/06

(57) ABSTRACT

A demountable hitching device for towing by vehicles, by means of an angled arm (6, 6′) with a horizontal section (17) for its coupling and a vertical section ending in an upper ball (7, 7′), including a baseplate or support (8, 8′) wherefrom a rod emerges vertically (9) or horizontally (16) for its coupling to a bush (1, 1′) of a cubic shape and with one open side, inferiorly or frontally, respectively. The device features a locking slide (15), displaceable along the rod (9) emerging from the baseplate (8) and guided by a longitudinal channel. In an alternative version, the locking means consists of a pin constituted by a ring (21) which is adjustable to the rod (9″) of the baseplate (8″); for this purpose, the rod (9″) presents a flat side with transversal grooves (20), and in a diametrically opposite position, a longitudinal groove (25) to house a lug (24) projecting inwards from a lateral wall (23) of the pin. The unlocking operation involves the exertion of downward pressure on a portion (26) of the pin projecting from the ring (21), or the use of an external tool such as a rack (28) or an angled clip (30).

### CROSS-REFERENCED TO RELATED APPLICATIONS

This application claims priority from Spanish Application Number 201830994 filed on Jun. 27, 2018, which is incorporated herein by reference in its entirety.

### TECHNICAL FIELD OF THE INVENTION

The present invention relates to a demountable hitching device for the towing of trailers by vehicles, of the type installed at the rear of a vehicle to tow a trailer, said device being of a demountable type, conceived and designed in such a way that the operations of assembly and disassembly of the same may be performed rapidly and in total safety. The device responds to a number of construction principles, presenting the characteristic of being usable for both a vertical device and a horizontal device.

The field of application of the present invention is comprised within the industrial sector devoted to the manufacture of towing items for cars in general.

### BACKGROUND OF THE INVENTION

It is universally known that many cars are equipped with a device for towing trailers, located at the rear of the vehicle, and equipped with an angled arm for its coupling with the hitching means featured on the trailer. These devices have evolved over time from those manufactured initially and usually installed immovably on the vehicle (that is, once installed, the user left them installed on a practically permanent basis), entailing the drawback of being devices projecting beyond the limit of the rear of the vehicle; to present-day hitches which are normally manufactured in the form of demountable devices, in such a way that the user may assemble and disassemble the same with ease when required. An example of a device of the demountable type has been described, among others, in the document of Utility Model ES-1 066 563 of this same applicant, wherein a universal assembly of arm and ball is able to be linked with a baseplate by means of the insertion of the extremity of said arm into a through-hole executed in the aforementioned baseplate; said baseplate further featuring an element stretching vertically and whose upper extremity ends in a staggered formation, presenting two surface levels at different heights. The fixed component of the hitch is constituted by two symmetric plates or halves, each of which features a recess which is prolonged toward a final curved portion to receive and lodge at least one lug solidary with said vertical element.

In comparison with the art prior to said document, the removable hitch disclosed in the same represented an extraordinary breakthrough in the ease and speed of assembly and disassembly of the removable hitch, also increasing the safety of the coupling.

### BRIEF DESCRIPTION OF THE INVENTION

Notwithstanding the above, continued research on this type of devices has enabled the execution of a hitching device presenting considerable improvements with regard to the devices in the state of the art, particularly regarding the simplicity of design and ease of use, with total guarantees of safety. In one embodiment, the hitching device is termed “vertical” due to the fact that the coupling with the locking bush is performed by means of a vertical movement, while in an alternative embodiment, the hitching device is termed “horizontal” due to the fact that the coupling is performed by means of a horizontal movement.

At this point in the description, it should be clarified that the terms “vertical” and “horizontal” should be understood bearing in mind the normal-use position of the device.

In accordance with the preferred embodiment of the invention, the device proposed features a locking bush and an arm and ball assembly. The bush, in its vertical assembly version, comprises a component of a generally cubic shape, lacking one of its faces to enable the attachment of the same to the attachment means of the vehicle, while the arm and ball assembly includes an angled arm, the vertical portion whereof ends superiorly at its forward extremity in a conventional ball, and whose rearward extremity of the horizontal portion includes a base of a likewise generally cubic shape, which at its upper side features a rod integrated with the same, emerging vertically and substantially parallel to the corresponding portion of the angled arm, and of a generally prismatic shape which at its upper section presents a furthest portion of greater dimensions. This furthest portion presents a longitudinal channel along which a sliding component may be vertically displaced in either direction. The aforementioned furthest upper portion of said rod is sized so as to be lodged in the interior of the bush, and further to enable the sliding component likewise to be located within the bush in order to lock the assembly in the assembled position. The bush further features a user-operable securing means to prevent the disassembly of the device in the coupled condition. Furthermore, the bush features a hole in one of its sides, and the upper furthest portion of the vertical rod features a ball, for the purpose of relative mutual positioning.

The horizontal assembly version of the device of the invention features exactly the same components, although the angled arm presents a horizontal section of a greater length and the coupling to the bush is performed via the frontal side of said bush instead of the upper side, as is the case with the vertical assembly device.

In a modified version, of a simplified design, the hitching device of the present invention comprises a support for its locking to the ball and arm assembly which includes a longitudinal hole, sized to receive the arm, and other transversal holes for the insertion of locking bolts, and featuring a rod emerging from the upper side, intended to be inserted into a corresponding axial hole of the bush through an open side of the latter, said bush presenting opposite-facing holes on two opposite lateral sides, and the rod displaying transversal grooves with regard to a flat side of the same, intended to receive locking bolts inserted through the opposite-facing holes in the lateral sides of the bush. The rod and the lodging hole thereof in the bush are sized so as to admit the insertion of a locking pin constituted by a ring-shaped base and a portion of the wall that emerges from said ring, perpendicular to the plane of the base, the base of the ring being susceptible to be inserted into the aforementioned rod by virtue of an axial hole in the same, and the portion of the wall of the locking pin featuring a lug perpendicular to said wall and directed inwards, intended to be inserted into a longitudinal groove in the rod in a diametrically opposed position to the cutaway side, and to be displaced along said groove when removed. Removal is performed with the aid of unlocking means acting on the base of the bush, for the displacement of the same in the direction of removal, which is achieved by virtue of the action of the lug on the wall of the bush against the extremity of the longitudinal groove in the rod. To this end, the invention has foreseen that the locking bush may be removed by acting directly on tabs on the base ring itself, by means of a rack device coupled to the support of the ball and arm assembly, the turning whereof causing the removal action, or even with the aid of a clip capable of acting upon a lug projecting outward from the circumference of the base ring.

### BRIEF DESCRIPTION OF THE DRAWINGS

These and other characteristics and advantages of the invention will be more clearly revealed in the detailed description below of a preferred embodiment of the same, provided exclusively as an illustrative example and in no way of a limitative nature, and referring to the accompanying drawings, wherein:

FIG. 1 is a schematic representation in perspective of the basic components of the bush and the arm and ball assembly of the demountable hitching device of the present invention, in its “vertical” assembly version;

FIG. 2 (portrayals A-F) is a sequence of operations during assembly and coupling of the demountable hitching device in FIG. 1;

FIG. 3 is a schematic representation in perspective of the components of the demountable hitching device of the present invention in the “horizontal” coupling embodiment;

FIG. 4 (portrayals A-F) is a schematic illustration of the sequence of assembly and coupling of the demountable hitching device in FIG. 3;

FIG. 5 is a schematic representation in perspective of a simplified version of the hitching device in accordance with the invention, in both assembled and disassembled states;

FIG. 6 portrays schematic perspective views of the locking pin employed in the modified version of the invention portrayed in FIG. 5, viewed from two opposite positions;

FIG. 7 portrays schematic perspective views of the aforementioned component termed ball support, viewed from two opposite positions;

FIGS. 8a and 8b present schematic perspective views of a first device for unlocking by gripping, in both its locked (inserted) and unlocked (removed) states;

FIGS. 9a and 9b present schematic perspective views of a second device for unlocking by sliding, in both its locked (inserted) and unlocked (removed) states, and

FIGS. 10a and 10b portray schematic perspective views of a third device for unlocking by means of a clip, in both its locked (inserted) and unlocked (removed) states.

### DESCRIPTION OF A PREFERRED EMBODIMENT

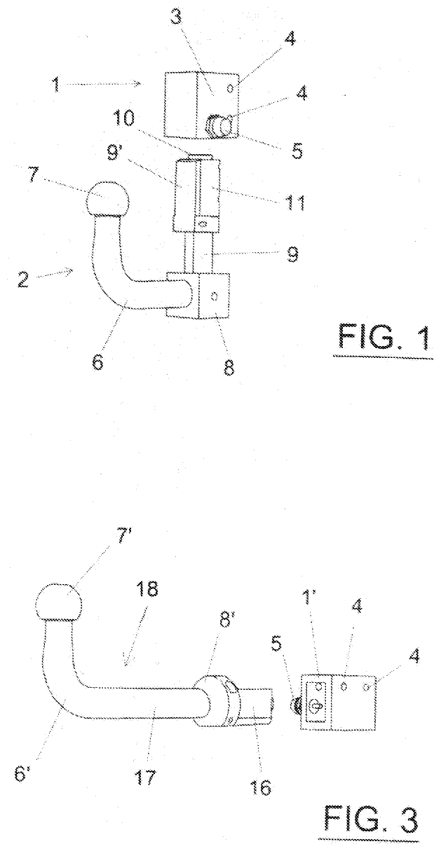

As has been mentioned in the foregoing, the detailed description of the preferred embodiment of the object of the invention will be made hereunder with the aid of the attached drawings, in which the same numerical references are used to designate identical or similar components. Thus, with reference firstly to FIG. 1 of the drawings, it may be seen that the device of the invention is comprised of a bush labelled throughout with the numerical reference 1, and an assembly of an arm and ball labelled throughout with the numerical reference 2. Both items, the bush 1 and the arm and ball assembly 2 portrayed in FIG. 1 have been designed in accordance with the embodiment foreseen for vertical assembly/disassembly.

The bush 1 consists of an item preferably adopting a generally cubic configuration, with a through-hole 3 centrally located on one of its sides, and through-holes 4 for the insertion of bolts for its locking to the attachment means of the vehicle. It also includes a safety locking device 5, this being user-operable in one direction or the other for the locking or unlocking of the same during the assembly or disassembly operations, respectively.

The arm and ball assembly in turn includes an angled arm 6 comprised of an upper stretch ending in a ball 7 of the conventional type, and whose horizontal stretch is solidarily linked, at its rear extremity, to a baseplate 8, likewise of a generally cubic shape but with smaller dimensions than those of the bush 1, and from whose upper side a rod 9 of a generally prismatic quadrangular shape emerges which, at a likewise prismatic quadrangular wide upper section 9′, increases in dimensions to constitute a sliding support (not visible in this Figure); for the purpose thereof it features a channel 10 running longitudinally throughout the length of one of its sides. It features a ball 11 on one adjacent side for its pairing with the hole 3 of the bush 1.

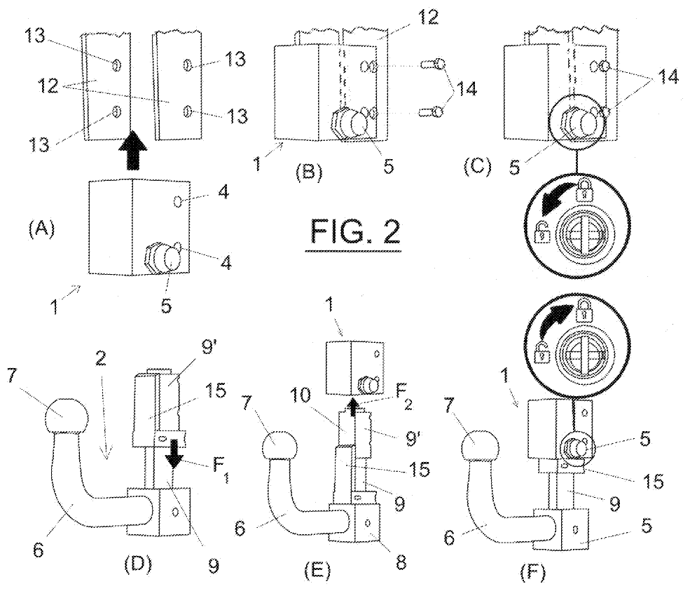

Observing FIG. 2 of the drawings, portrayals (A) to (F) illustrate a sequence of assembly and coupling of the hitching device of the present invention, in its vertical assembly variant. Portrayal (A) shows the bush 1 in position, facing the attachment means 12 solidary with the vehicle; said means feature holes 13 susceptible to face the holes 4 of two facing sides of the bush 1. Portrayal (B) illustrates the operation of linking the bush 1 of the device of the invention and the attachment means 12 of the vehicle, passing bolts 14 through the holes 4 facing the aforementioned holes 13. This situation is clearly visible in portrayal (C), where the bolts 14 have been tightened; at this stage the safety lock 5 may be actuated to the open position. In portrayal (D), the arm and ball assembly may be seen equipped with the locking slide, labelled with the numerical reference 15, and which in the resting position is pressed toward the upper part, as may be seen in the aforementioned portrayal, it being displaceable along the guide 10, as indicated by the arrow F₁. With regard to portrayal (E), it may be seen that the arm and ball assembly will be coupled to the bush 1 by means of the insertion of the upper portion 9′ of the vertical rod 9 within the bush 1, through the base of the latter, as indicated by the arrow F₂; to this end, the locking slide 15 has been lowered. Finally, having performed the insertion of the portion 9′ into the bush 1, the assembly will adopt the configuration displayed in portrayal (F); to achieve this it is sufficient to release the locking slide 15, the hitch thus resulting assembled. Actuating the safety lock 5 to the locked position will prevent any possibility of disassembling the assembly.

As will be evident, when the assembly is to be disassembled, the operations should be performed in the reverse order to that of assembly, that is, first the safety element 5 should be actuated in the unlocked direction, and then the locking slide 15 should be lowered in the direction of the arrow F₁, the arm and ball assembly thus being freed to be removed from the bush 1.

Once again, it should be clarified that the terms “upper”, “lower”, “up” and “down” should be understood in accordance with the position in which the components appear in the drawings, which also coincides with the real position of assembly of the unit.

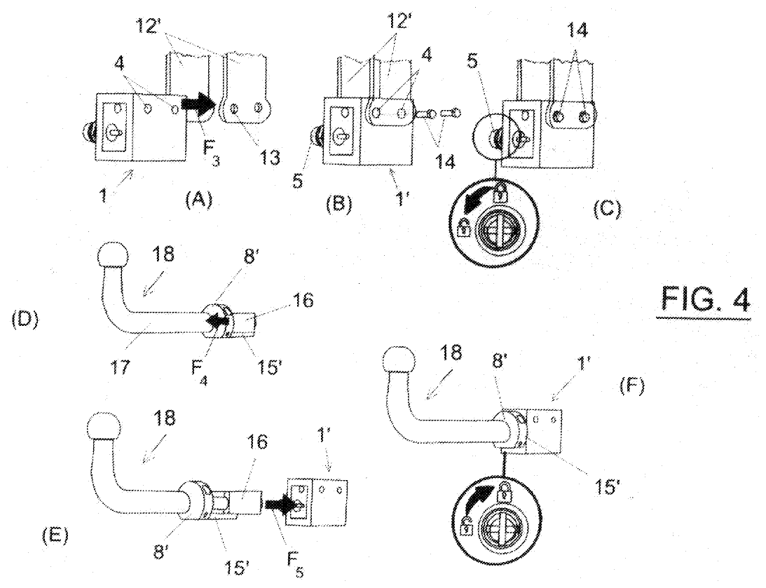

With reference now to FIG. 3 of the drawings, a schematic portrayal is shown of a demountable hitching device for towing by vehicles of the horizontal type, designed according to an embodiment following the same philosophy of construction and use as the embodiment of the vertical type, with the same components, although adapted for this horizontal method of assembly. Thus, it portrays an arm and ball assembly 1′ comprised of an angled arm 6′ featuring a vertical section ending in a conventional upper ball 7′, and a horizontal section of a greater length than the vertical section, ending in a baseplate 8′ adopting a generally cylindrical shape, of reduced height, capable of moving along a guide 17 executed along the horizontal section of the angled arm 6′, a rear portion 16 of the horizontal section 6′ of the angled arm extending behind said baseplate 8′ and featuring a half-round cross-section, said baseplate 8′ being able to receive a locking slide component (not visible in this Figure), said baseplate 8′, together with the rear portion 16 of the angled arm 6′, being able to be coupled within a bush 1′, which is of a generally cubic shape and is open at its forward side. The bush 1′ features through-holes 4 on both facing lateral sides, and also features a safety element 5, operable in both directions, unlocked and locked.

In turn, FIG. 4 shows a set of portrayals referenced as (A) to (F), illustrating a sequence of assembly. With reference to said Figure, portrayal (A) shows attachment elements 12′ corresponding to the towing vehicle, featuring holes 13 prepared to face the holes 4 of the bush 1′ when the latter is coupled to said attachment elements as indicated by the arrow F₃; portrayal (B) shows this coupled situation of the attachment elements 12′ and the bush 1′, with the bolts 14 facing the holes 4; portrayal (C) shows the assembly of said bush 1′ and attachment elements 12′, and the linking of both with the bolts 14 tightened in their corresponding position; portrayal (D) shows the arm and ball assembly 1′ with the locking slide 15′ coupled to the cylindrical baseplate 8′, with both elements prepared to be displaced as indicated by the arrow F₄ along the guide 17; portrayal (E) shows both elements, the baseplate 8′ and the locking slide displaced for the insertion of the rear portion 16 into the bush 1′, as indicated by the arrow F₅, and portrayal (F) shows the assembly once set up and with the slide 15′ in the locked position. The safety element 5 may be rotated, with regard to portrayal (C), in the unlocking direction, while in the position shown in portrayal (F), said safety element should be rotated in the locking direction, that is, the direction that prevents disassembly of the setup.

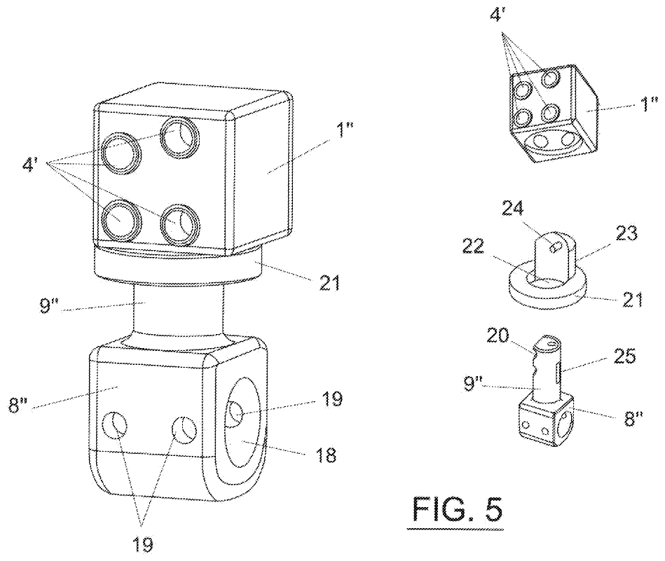

With reference now to FIG. 5 of the drawings, a schematic portrayal in perspective may be seen of a modified version of the hitching device in accordance with the invention. As may be seen, the hitching device comprises a bush of the type described above, identified with the numerical reference 1″, which also features a cubic configuration such as those described above, and which presents one of its sides (that in the lowest position in the drawing) open for the insertion of the rod 9″ of a supporting component 8″ of the arm and ball assembly (not visible in the Figure), and featuring an approximately cubic shape. The bush 1″ features, in two facing lateral sides, holes 4′ for the passage of bolts (not portrayed).

Likewise, the supporting component 8″ of the arm and ball assembly features a hole 18 extending horizontally according to the longitudinal axis of the component, and sized to accept the passage of an arm 6, 6′ (FIGS. 2 and 4), while on both lateral sides it features holes 19, in opposite-facing positions, for the passage of bolts for the locking of the arm within the hole 18, once said arm has been inserted into the longitudinal hole 18. In turn, the rod 9″ of the supporting component of the arm and ball assembly is of a generally cylindrical configuration, but with one cutaway, flat side, with transversal grooves 20 in specific locations coinciding with two of the holes 4′ in the bush, in such a way that the fixing of the rod in the locked position may be performed by passing bolts through pairs of facing holes 4′ in the bush 1″. Furthermore, in a position diametrically opposite the flat face, the rod features a groove 25 stretching along a determined length of said rod 9″.

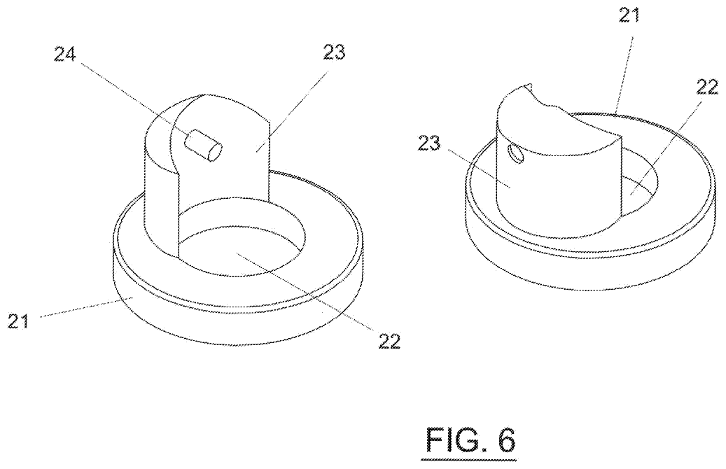

The locking element, which is more clearly visible in the schematic perspective portrayals of FIG. 6, is generally ring-shaped, with a flat base 21 enclosing a central axial hole 22, and is sized for its insertion into the rod 9″, from the base whereof a portion of cylindrical wall 23 emerges perpendicularly to the base 21, and featuring a lug 24 facing orthogonally inwards.

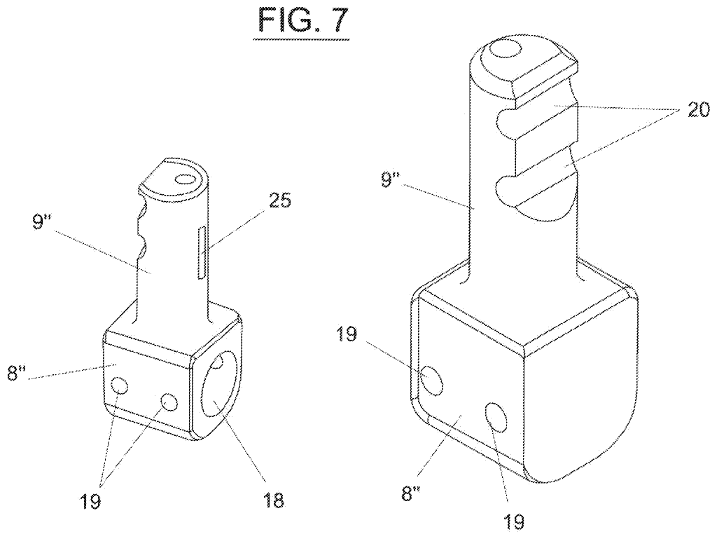

The supporting component 8″ may be seen in the portrayals of FIG. 7, which display with greater clarity the transversal grooves 20 executed in the cutaway portion of the rod 9″, likewise the longitudinal groove 25. The latter is sized complementarily with the lug 24 of the locking element, wherein it is inserted with the possibility of longitudinal displacement.

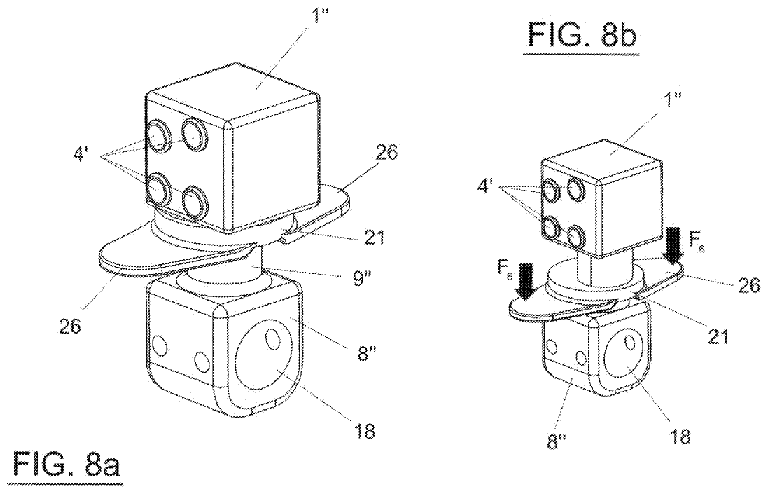

The coupling of the components portrayed in FIG. 5 is as portrayed in said Figure. However, the configuration adopted by the base 21 of the locking pin may vary according to different embodiments; in which case unlocking means or tools suited to the configuration adopted by said locking pin will be required. In the embodiment in FIGS. 8a and 8b, it may be seen that the base 21 has been equipped with flat tabs 26, projecting radially outwards from diametrically opposing positions on the base 21, and whereon a downward pressure (according to the position in the drawing) may be exerted, identified by the arrows F₆ in FIG. 8b. It may therefore be understood that FIG. 8a illustrates the locked condition (pin inserted), while FIG. 8b corresponds to the unlocked position (pin removed).

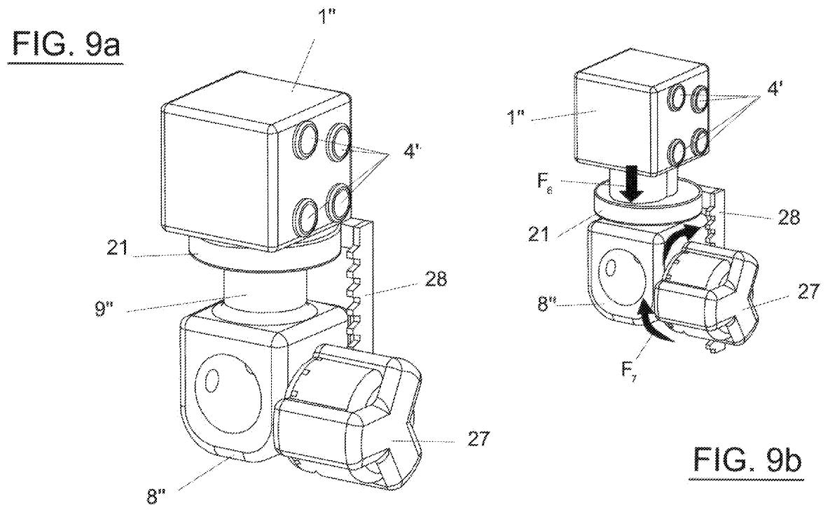

Likewise, in another preferred embodiment, the locking pin may be removed by using an external tool such as that portrayed with reference 27 which, adapted to one of the respective holes 19 in the support 8″, can cause said pin to descend (as indicated by the arrow F₆) by pulling the ring 21 by means of a slide 28, executed in the form of a rack, by actuating the tool 27 in the direction portrayed by the arrow F₇ in FIG. 9b (unlocked position).

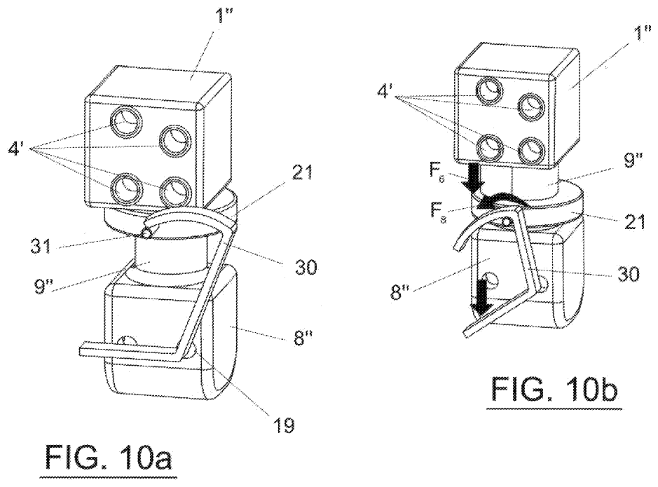

Finally, the extraction means may consist of a tool in the form of a clip, of the type identified by the numerical reference 30 in FIGS. 10a and 10b, configured in an open “C”-shape with two straight branches and one curved branch which, pivotingly coupled to one of the holes 19 and with its rounded branch applied against a lug 31 projecting radially outwards from the circumference of the ring 21, causes the locking pin to move from the position portrayed in FIG. 10a (locked position) to the position portrayed in FIG. 10b (unlocked position), as indicated by the arrow F₆, when the clip 30 is caused to pivot in the manner indicated by the arrow F₈.

In all cases, the displacement of the locking pin with regard to the rod 9″ of the support 8″ is aided by the displacement of the lug 24 projecting from the wall 23 of the pin, within the groove 25 stretching longitudinally along the rod 9″. This coupling of the lug 24 within the longitudinal groove 25 causes the locking pin to be prevented from rotating when force is applied to the same during the unlocking operations.

### INDUSTRIAL APPLICABILITY

The demountable hitching device described with regard to the present invention, together with the unlocking devices likewise described in the foregoing, is applicable to the industrial sector devoted to the manufacture and installation of ball hitches for cars, for the towing of trailers.

It is not considered necessary to make the content of the present description more extensive for a person skilled in the art to understand its scope and the advantages derived therefrom, as well as to carry out the practical embodiment thereof.

Notwithstanding the foregoing, and given that the description made herein corresponds solely to an example of a preferred embodiment of the invention, it will be understood that within its essential nature, multiple variations in detail, likewise protected, may be introduced and which might affect the shape, size, or manufacturing materials of the assembly or of its components, without this entailing any modification of the invention as a whole, defined solely by the claims set out below.

1. A demountable hitching device for towing by vehicles, specifically a hitching device of the ball type featuring an angled arm (6; 6′) with one horizontal section and another vertical section ending superiorly in a conventional ball (7; 7′), characterised in that, in a vertical assembly version, the horizontal section of the angled arm (6) features at its free extremity a baseplate or support (8; 8″), of a generally cubic or pseudo-cubic shape, from whose upper base a vertical rod (9; 9″) emerges, it having a prismatic shape, quadrangular in cross-section, or where applicable, a generally cylindrical shape, where the baseplate (8) features an upper portion (9′) of like configuration and greater dimensions in its transversal cross-section, equipped with a ball (11) at one of its sides, each upper portion (9; 9″) being able to be lodged respectively in the interior of a bush (1; 1″) of a generally cubic configuration, through the lower base of the latter, and the aforementioned bush (1; 1″) featuring through-holes (4; 4′) in two opposite-facing sides, sized to enable the passage of bolts (14) for their linking to attachment elements (12) on the vehicle which likewise feature respective holes (13) to face the holes (4; 4′) in the bush (1; 1″).

2. The device of claim 1, characterised in that it features a locking slide (15) displaceable along the rod (9, 9′) emerging from the baseplate (8), guided by a channel (10) stretching longitudinally along one side of the portion (9′).

3. The device of claim 1, characterised in that the bush (1) features a safety element (5) which is user-operable in opposite opening and closing directions, to bring about the freeing and disassembly of the device, or to lock the device in the assembled condition, respectively.

4. The device of claim 2, characterised in that the bush (1) features a safety element (5) which is user-operable in opposite opening and closing directions, to bring about the freeing and disassembly of the device, or to lock the device in the assembled condition, respectively.

5. The device of claim 1, characterised in that in a horizontal assembly version, the angled arm (6′) features a horizontal section of a considerably greater length than the vertical section, and features a guiding channel for a baseplate (8′) and a locking slide (15′) coupled to said baseplate (8′).

6. The device of claim 5, characterised in that it features a bush (1′) of a generally cubic shape, open at its frontal side, adapted to be coupled to the rearward portion (16) of the horizontal section of the angled arm (6′) and to house therein the locking slide (15′), said bush (1′) featuring holes (4) for the linking of the same by means of bolts (14) to the attachment elements (12′) of the vehicle.

7. The device of claim 1, characterised in that the support (8″) incorporates a rod (9″) for its coupling to the bush (1″); said rod (9″) is of a generally cylindrical shape but with one portion being cutaway and flat, whereon transversal grooves (20) have been executed; the rod (9″) also featuring a groove (25) stretching longitudinally in a diametrically opposite position to said flat portion.

8. The device of claim 1, characterised in that it comprises a locking element constituted by a generally ring-shaped component featuring a flat, circular base (21) enclosing a central axial hole (22), sized for its insertion into said rod (9″), from the base whereof a portion of a wall (23) of a curved configuration emerges in a longitudinal direction, wherefrom a lug (24) facing orthogonally inwards and sized to be housed in the aforementioned longitudinal groove (25) in the rod (9″) projects.

9. The device of claim 7, characterised in that it comprises a locking element constituted by a generally ring-shaped component featuring a flat, circular base (21) enclosing a central axial hole (22), sized for its insertion into said rod (9″), from the base whereof a portion of a wall (23) of a curved configuration emerges in a longitudinal direction, wherefrom a lug (24) facing orthogonally inwards and sized to be housed in the aforementioned longitudinal groove (25) in the rod (9″) projects.

10. The device of claim 7, characterised in that the device features unlocking means for the removal of the rod (9″) from the interior of the bush (1″), which in different embodiments may consist of tabs (26) projecting from diametrically opposing positions on the base (21) of the locking pin, of a tool (27) susceptible to be coupled to the support (8″) at one of the holes (19) executed in two lateral facing sides of the support and equipped with a slide element (28), configured in the form of a rack, or a device in the form of a clip (30), prepared for its coupling by pivoting in one of the holes (19) of the support (8″) and configured in an irregular open “C”-shape, with a curved branch resting against a lug (31) projecting radially outwards from the circumference of the base (21) of the ring.

11. The device of claim 8, characterised in that the device features unlocking means for the removal of the rod (9″) from the interior of the bush (1″), which in different embodiments may consist of tabs (26) projecting from diametrically opposing positions on the base (21) of the locking pin, of a tool (27) susceptible to be coupled to the support (8″) at one of the holes (19) executed in two lateral facing sides of the support and equipped with a slide element (28), configured in the form of a rack, or a device in the form of a clip (30), prepared for its coupling by pivoting in one of the holes (19) of the support (8″) and configured in an irregular open “C”-shape, with a curved branch resting against a lug (31) projecting radially outwards from the circumference of the base (21) of the ring.
